(19) United States
(12) Patent Application Publication
(10) Pub. No.: US 2018/0091406 A1
(43) Pub. Date: Mar. 29, 2018

(54) USER DEFINED PROTOCOL FOR SELF CORRECTING ZERO-ADDED-JITTER TRANSMISSION OF LAYER-2 DATAGRAMS ACROSS ONE-WAY LOSSY PACKET-SWITCHED NETWORK LINKS

(71) Applicant: Sergio Ammirata, Coral Springs, FL (US)

(72) Inventor: Sergio Ammirata, Coral Springs, FL (US)

(21) Appl. No.: 15/275,815

(22) Filed: Sep. 26, 2016

(51) Int. Cl. H04L 12/26; H04L 29/06

(52) U.S. Cl. CPC H04L 43/0852; H04L 65/4076; H04L 65/80

(57) ABSTRACT

A zero-added-jitter protocol for accurate transmission of datagrams over packet-switched networks between two or more microprocessor devices connected such that data may pass in one direction only; also reproducing the timing and inter-packet spacing of that which was originally received, along with a pre-configured time-delay for error correction.

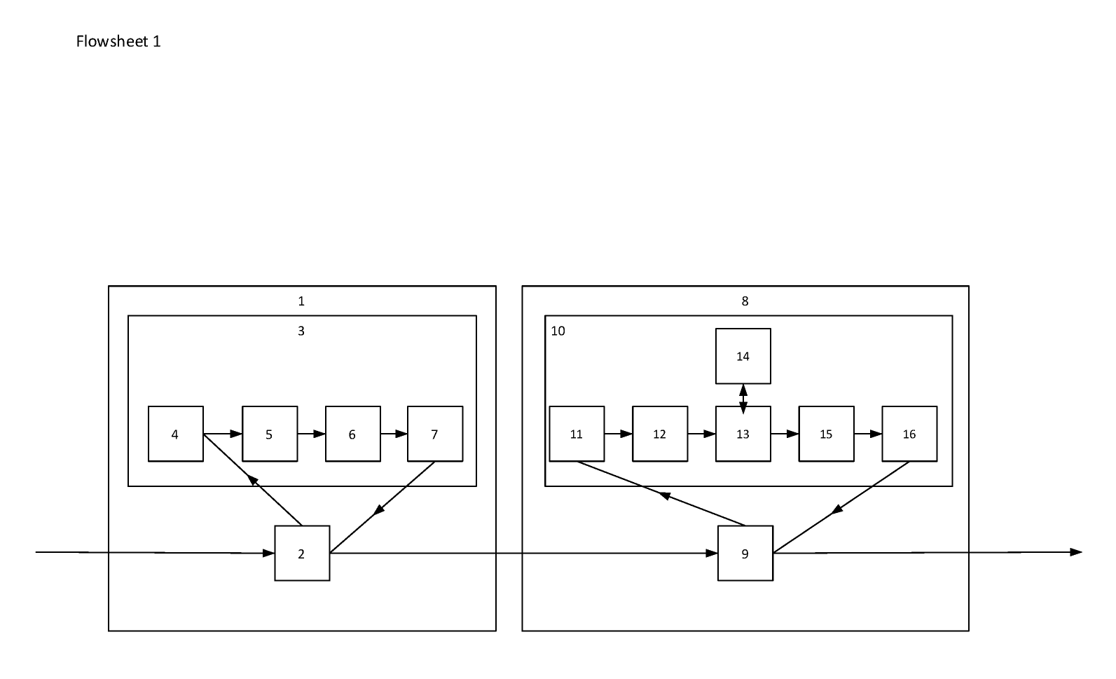

### FIELD OF THE INVENTION

The work relates to the field of streaming media protocols over public packet switched networks such as the Internet, specifically to mechanisms that correct for packet loss due to congestion, router queue overflow or other transmission errors sometimes present when sending large bursts of data with particular focus on one-way network protocols (such as udp unicast or multi-cast IP) or physically limited to a single direction in their flow of data (such as receive-only satellite connections).

Additionally, multi-cast IP over semi-private networks such as that of a cable TV/ISP provider also presents particular problems in that many observers forecast that broadcast TV may transition to streaming large amounts of TV channel content via multi-cast IP to set-top-boxes; in such networks the cable ISP assigns public addresses yet runs all routers in the network enabling multicast, but in many cases the physical layer of the network may be older and more liable to problems that cause transmission errors.

### BACKGROUND OF THE INVENTION

Network problems due to congestion, overflow or other errors produce dropouts, a temporary loss of all or part of video or sound in a media stream caused by loss of data, and/or jitter, a jerkiness of motion or stuttering of sound produced by variation in the rate of the arrival of stream data containing the media.

Various prior art in the field includes re-request mechanisms; buffering; and packet recovery/forward error correction (FEC).

In general, FEC methods compute row (horizontal) and column (vertical) parity packets on a block of data packets using an XOR operation. They use a vertical parity packet to recover a missing data packet in a column and a row parity packet to recover a missing data packet in a row. Complex FEC methods add interleaving and variations in matrix sizes in order to transmit more or less corrective data. Setting the size of blocks for the parity computation determines how large a failure the receiver can recover from. The greater the granularity of the FEC data, the greater the ability to tolerate transmission errors and rebuild dropped packets or even a series of dropped packets. But the greater the granularity, the larger the quantity of FEC data required. These arts may therefore substantially increase the volume of transmitted data as well as the number of network transactions to communicate the data (especially in a two-way network).

U.S. Pat. No. 3,387,261 (1968 Betz) describes the detection and correction of errors in data during transfer from memory to storage. It uses an XOR operation to compute the parity bits, generating a parity bit for successive frames.

U.S. Pat. No. 6,145,109 (2000 Schuster, Mahler, Sidhu, Borella) describes the concatenation of redundancy blocks to the next-in-order payload blocks in a one-dimensional column structure.

U.S. Ser. No. 12/358,181 (2009 Melliar-Smith, Moser, Koh) describes a configurable multi-dimensional matrix of intertwined stream data and forward error correction data such that analysis of the received matrix identifies any missing packets by relative location within the matrix. Reconstruction of the missing packets can be implemented according to a formula using the FEC data in matrix members in either horizontal, vertical diagonal spatial relation to the missing packet. Where the FEC data is insufficient, the location missed may be forwarded to a re-request mechanism, which sends a message to the transmitter requesting a re-send of the missing packet. U.S. Ser. No. 12/358,181 also adds separate data paths (UDP ports) to make it backwards compatible with existing protocols that specify fewer dimensions of the FEC data, and which transmit that data in the same data path as the media stream data.

The present invention differs from U.S. Pat. No. 3,387,261, U.S. Ser. No. 08/989,616 and U.S. Ser. No. 12/358,181 in that it compresses both stream data and FEC data. This allows the invention to make the overall network traffic more efficient, vital because any type of Forward Error Correction adds to network traffic by at least the size of the error correction data. The more efficient the traffic, the greater the capacity to transmit a greater amount of FEC data. The invention provides configurable levels of FEC data interleaved with the stream data in a two-dimensional matrix. By increasing the efficiency of the network transmission with compression, a higher degree of FEC data can be sent over a given bandwidth. This reduces the need for a re-request mechanism, making the present invention more suitable for one-way network protocols such as multi-cast. For the case cited previously, that of a cable ISP's semi-private network emitting large amounts of streaming via multi-cast IP, such a purely one-way error correction protocol which is compact at the same time may enable the provision of additional channels and/or better quality transmission of those channels where the physical plant may not be optimal.

U.S. Ser. No. 12/358,181 is an example of other inventions which may utilize one-way network protocols such as udp unicast, but add a re-request mechanism via a separate communications channel which requires additional traffic in the reverse direction to request resend of missing, unrecoverable packets, so that the invention is not a completely a one-way protocol.

The present invention further differs from U.S. Pat. No. 3,387,261, U.S. Ser. No. 08/989,616 and U.S. Ser. No. 12/358,181 because it tags each datagram header with a sequence number. This not only provides quicker identification of lost packets with less effort by the processor, but also identifies out-or-order and duplicate packets, which can then be placed in the right position or discarded, obviating the need to re-request or re-compute the out-of-order packet from FEC data. Reducing re-requests further makes the invention more suitable for one-way network protocols.

The present invention also differs in that the transmitter encodes a desired interval rate into the datagram header, padding the datagram payloads if necessary, so that the receiver may reassemble the stream at a rate equal to that at which if left the transmitter, eliminating network-produced jitter.

Various professional streaming media standards, such as SMTPE 2022, include Forward Error Correction and also provide for synchronizing playback by the receiver player to the original or intended rate of playback by specifying a constant bit rate as part of the standard. Once the stream begins to arrive at the receiver, knowing the bitrate, the player can reassemble lost packets from FEC data and play them at the correct time by calculating the correct synchronized time according to its position in the stream. Using a buffer, such a player can play a stream without dropouts and at a rate equal to that intended by the author of the stream. The current invention differs from such standards in that it supports variable bitrate streams, which are more efficient and reduce the necessary network bandwidth, leaving further room to increase the FEC data.

U.S. Ser. No. 14/173,183 (2016, by the same author as this invention) also describes a process of tagging an inter-packet interval value. The present invention uses the same mechanism so that together with Forward Error Correction, which is not present in U.S. Ser. No. 14/173,183, and by virtue of the previously described compression, it can enable very robust FEC configuration in the same amount of bandwidth versus FEC without compression, so that the receiver can rebuild lost packets and insert them at the correct time for jitter-free playback. Additionally, in U.S. Ser. No. 14/173,183, though it has a re-request mechanism, the primary determinant upon overall error control for the entire process is the buffer size, because it has more effect on how many re-requests will be issued. In the current invention, without re-request, the main determinant is the configuration of the size of the virtual bandwidth. This is because in a one-way network, it is the main factor affecting how much stream data and FEC data the transmitter may send.

U.S. Pat. No. 6,745,364 B2 (2004, Bhatt, Machin) describes a request mechanism from client to server by which the client may request a specific, configurable level of Forward Error Correction at the start of transmission. This differs from the current invention in that it requires a two-way networking control protocol to set up the stream and offers no compression, nor the means to exactly duplicate the rate of the arrival of stream data containing the media. In this invention the server dictates the configuration of the FEC data level.

U.S. 65/556,588 BW (2003, Wan Morin) describes the addition of FEC data to a compressed MPEG stream, which may be optionally discarded by clients unable to utilize the FEC data. This differs from the current invention in that the FEC data is uncompressed, nor does it provide the means to exactly duplicate the rate of the arrival of stream data containing the media.

U.S. Pat. No. 6,167,060 A (2000, Vargo, Chang), like 2004, Bhatt, Machin, describes a dynamically configurable level of FEC for media streams by which a client can signal to the server to increase or decrease the level during transmission. This differs from the current invention in that it is unsuitable for a one-way network, and that the FEC data is uncompressed; nor does it provide the means to exactly duplicate the rate of the arrival of stream data containing the media. In this invention the server dictates the configuration of the FEC data level, and that this level is not changeable during transmission. Compression allows the present invention to set a higher level of FEC data, and it continues at that level, whether network conditions require a high level of data recovery or not.

U.S. Pat. No. 7,539,187 B2 (2009 Fellman, Bear) describes a Forward Error Correction method with time-stamping. The use of the timestamps is to limit the amount of FEC data, unlike the current invention which uses sequence stamping and the virtual packet size calculator to reproduce the rate of data received at the transmitter, on the client side, according to the configured virtual bandwidth. The same effect is delivered through a different method.

Finally, in certain networks QOS prioritization and/or traffic shaping are utilized to enhance delivery of the streaming media. Both are normally limited to private networks, and not generally available when streaming from one public Internet address to another. Whereas when other protocols sending FEC data in non-prioritized packets transverse a QOS enabled router the packets may be slowed down (including by the additional “weight” of the FEC data) while the router handles other, high-prioritized packets, the ability of the present invention to duplicate the original speed allows it to further enhance the delivery of streams by faithfully reproducing the appropriate stream without jitter.

### DESCRIPTION FLOWSHEET 1

In Flowsheet 1 of the present invention, the transmitting microprocessor device (1) must first receive the incoming datagrams which it is to retransmit. These datagrams arrive via the network facing provider edge device (2), to the datagram processing module (3).

As each datagram arrives, a counter unit (4) tags the datagram with a sequence number.

The virtual packet size calculator (5) analyzes the original instantaneous bitrate and inter-packet spacing of the incoming packets. The virtual packet size calculator has been configured by the user with a predefined bitrate capacity, i.e., a desired bandwidth for the egress of the packets.

The virtual packet size calculator calculates a virtual packet size based on the bytes required to fill a private wire of the predefined bitrate capacity in a time equal to the inter-packet interval between the current and previous incoming datagrams. This provides the receiver with the data necessary to replicate the speed at which the datagrams containing the stream originally arrived at the transmitter.

The virtual packet size calculator tags the datagram with that calculated virtual packet size.

The forward error correction unit (6) calculates a configurable level of FEC and interleaves it with the stream data, such as

0 1 2 3 4 5 6 7 8 9 R0 10 11 12 . . . R1 . . . . R2 . . . 41 C1 42 C2 43 C3 44 C4 . . . 49 R4 C9

where “R” stands for an FEC data value calculated for a row, and “C” stands for FEC data calculated for a column. The FEC module maintains FEC data in the same frame as the stream data, which allows for better handling should data arrive from multiple links (i.e., the FEC data always arrives on the same link as the stream data; no need to wait on the other link).

The data compression module (7) compresses the tagged packets interleaved with the FEC data.

The compressed and tagged datagram is sent out through the virtual provider edge device.

At the receiving microprocessor device (8), incoming datagrams arrive via the network facing provider edge device (9), to the receiver datagram processing module (10).

The received datagrams are uncompressed by the data decompression module (11).

The decompressed data is separated into stream and FEC data by the datagram parser module (12).

The datagram parser module examines the sequence number, and discards duplicates (by comparing tagged sequence numbers). If not a duplicate, it is forwarded to the datagram buffer module (13).

The FEC data recovery module (14) examines the buffer, identifies any missing packets and rebuilds them.

For the datagrams stored in the datagram buffer module, the gate (15) reads the tagged virtual packet size, and with it, releases the datagrams on a first-in, first-out basis using the following algorithm:

A total value of virtual bytes (TVVB) is calculated for the entire buffer using the sum of all the virtual packet sizes for all the packets stored in it.

A fixed virtual total target buffer size (VTTBS) is calculated using the bitrate of the private wire (BPW) and the desired delay (DD) using this formula: VTTBS=BPW (bytes/seconds)×DD (seconds)

The gate will output datagrams to the data restoration unit (16) at a rate that keeps TVVB=VTTBS.

The data restoration unit strips the tags and FEC data added by the invention, and sends the datagrams out through the network facing provider edge device (8).

This produces a rate and inter-packet spacing matching the incoming inter-packet spacing as calculated by the virtual packet size calculator, while at the same time provides a fixed precise delay. The data restoration unit strips tags and FEC data added by the invention, and the packets are released to the network facing edge provider.

By having matched the rate and inter-packet spacing, the invention has transported the datagrams without additional jitter, while adding a buffer in which to correct errors in transmission.

1. A method for one-way transmission of datagrams such as those containing multimedia streams over packet-switched networks from one microprocessor device to one or more connected microprocessor devices with greater accuracy and zero-added jitter comprising:
the inclusion of a greater amount of recovery data for a given bandwidth through the compression of both stream and recovery data, enabling increased reconstruction of missing packets, even when no re-request process is available, such as in one-way network protocols such as multi-cast, uni-cast IP, or one-way satellite, and even at relatively high levels of network packet loss;
a simplified process for the correction of out-of-order, duplicated, or missing packets by virtue of a sequence number tag added to each packet, allowing relocation (within a buffer on the receiver) in numeric order, removal where duplication of the sequence number tag is identified, or reconstruction from recovery data where sequence number tags indicate a missing sequence number(s) without use of a re-request process;
the reproduction on the receiving device(s) of the instantaneous bitrate and packet spacing of a media stream thus transported, being equal to that originally received by the transmitting device, via tagging each packet with a virtual packet size in accordance with a formula derived from a desired virtual bandwidth, resulting in zero-added jitter;

2. The method of claim 1 further comprising the steps of
A transmitter datagram processing module within the microprocessor device comprising
A network facing provider edge device through which the incoming layer 2 datagrams arrive at the transmitter datagram processing module;
A counter unit which tags each incoming datagram with a sequential, numeric ID;
A virtual packet size calculator which analyzes the instantaneous bitrate and inter-packet spacing of the incoming packets, calculates a virtual packet size based on the bytes required to fill a private wire of a desired bitrate capacity in a time equal to the inter-packet interval between the current and previous incoming datagrams, and which tags the datagram with the virtual packet size;
A forward error correction unit which calculates FEC data in both horizontal and vertical dimensions of a configurable matrix and interleaves it with the stream data within the packet;
A data compression module which compresses the tagged packets interleaved with the FEC data;
A network facing provider edge device through which the outgoing layer 2 datagrams depart the transmitter datagram processing module;
A receiver datagram processing module comprising
A network facing provider edge device through which the incoming layer 2 datagrams arrive at the receiver datagram processing module;
A data decompression module which decompresses the tagged packets interleaved with the FEC data;
A datagram buffer module which stores the packets;
A datagram parser module which receives the packets from the data compression module, and routes packets to the datagram buffer module; the parser reads the sequence number and appends packets to the end of the buffer; if the sequence number is greater than the last packet in the buffer, it calculates a location for the correct placeholder for it, places the packet there, leaving a “hole;” if the sequence number is less than the last packet in the buffer, and a hole is present, it places the packet in the hole, correcting for out-of-sequence packets; if the sequence number is less than the last packet in the buffer, and a hole is not present, it discards the packet, correcting for duplicate packets;
An FEC data recovery module which examines the buffer and if a “hole” is still present, rebuilds missing packets from FEC data, within a time limit based upon the size of the buffer;
A gate which controls the release of datagrams in accordance with the “speed” required to maintain the calculated virtual packet size, removing the datagram from the datagram buffer module as it releases them;
A data restoration unit which removes the tags and FEC data which were added to the packets;
A network facing provider edge device through which the outgoing layer 2 datagrams depart the transmitter datagram processing module;
